(19) United States
(12) Patent Application Publication
(10) Pub. No.: US 2002/0047798 A1
(43) Pub. Date: Apr. 25, 2002

(54) IMAGE ACQUISITION AND RETRIEVAL SYSTEM EMPLOYING POSITION DATA

(76) Inventor: TIMOTHY JAMES PLATT, ANDOVER, MA (US)

Correspondence Address: LAHIVE & COCKFIELD, 28 STATE STREET, BOSTON, MA, 02109, US

(21) Appl. No.: 09/344,231

(22) Filed: Jun. 25, 1999

(51) Int. Cl. G01S 5/14

(52) U.S. Cl. 342/357.12

(57) ABSTRACT

An image reproducing system and method for reproducing an image of an object, the system having storage for storing image data associated with the image. The system acquires an image an image of the object, acquires position data representative of the position of the object, correlates the position data with the image data associated with the image, and retrieves the image data based upon the position data.

### BACKGROUND OF THE INVENTION

The present invention relates to an image acquisition and retrieval system for acquiring or receiving an image of an object and for retrieving the acquired image. More particularly, the present invention relates to an image acquisition and retrieval system that employs position data to retrieve image data.

Conventional image acquisition devices, such as digital cameras, are well known and are widely used. A conventional digital camera employs an image acquisition element, such as a charge-coupled device (CCD) array, to acquire an image of an object. The image is converted into digital image data, and then stored in memory. The memory is typically located on-board the camera. Hard copies or photographs of the image can then be made by downloading the image data to a printer.

Today, individuals typically store the photographs in a conventional book-type or hard copy medium, such as a photo album. Other storage techniques involve digitally storing the images in a storage medium, such as in memory of a traditional personal computer. A common problem exists with regard to the individual's ability to locate and to retrieve quickly and immediately a particular image stored in memory. In general, people attempt to retrieve the image by scanning through the photo album, or by accessing, retrieving and then viewing a particular stored image, and if the image is not the desired image, repeating the procedure multiple times until the desired image is located.

A drawback of this conventional image retrieval technique is that it is relatively time consuming since the individual retrieves and views the images one at a time. Although the individual can create elaborate files that store particular photographs therein, the individual generally needs to remember the contents of each file in order to expedite the image retrieval process.

Due to the foregoing and other shortcomings of conventional image acquisition and retrieval systems, it is an object of the invention to provide an image acquisition and retrieval system that provides for relatively easy access and retrieval of a desired image.

It is another object of the invention to provide an image acquisition and retrieval system that allows for relatively rapid retrieval of the desired image.

Other general and more specific objects of the invention will in part be obvious and will in part appear from the drawings and description which follow.

### SUMMARY OF THE INVENTION

The present invention provides for an image acquisition and retrieval system that acquires an image of an object, as well as data corresponding to the position of the object. The acquired position data is correlated with the image data, and then stored in memory to form an image database. The system then searches the image database to retrieve selected ones of the stored images that correspond to user defined search criteria.

This invention attains the foregoing and other objects with an image reproducing system for reproducing an image of an object, the system having storage for storing image data associated with the image. The system employs a method for retrieving selected image data, comprising the steps of acquiring an image of the object, acquiring position data representative of the position of the object, correlating the position data with the image data associated with the image, storing the image and position data and retrieving the image data based upon the position data.

According to one aspect, the step of retrieving comprises the step of retrieving selected image data having correlated therewith position data related to a user defined threshold.

According to one aspect, the method comprises the step of receiving position signals from a global positioning system (GPS) satellite constellation. The position signals are representative of a geographical location of the object. According to another aspect, the step of retrieving comprises the steps of providing user defined data representative of a geographic location, searching the position data for data related to the user defined data, and retrieving the image data correlated with the selected position data. For example, the method can select position data relative to the user defined data that is within a selected geographic vicinity of the user defined data. This enables the system to retrieve image data associated with the selected position data that falls within a selected geographic vicinity of the geographic location represented by the user defined data.

According to another aspect, the method includes providing an indexing facility having a search engine for indexing the image and position data, and searching with the search engine the position data having correlated therewith related to the user defined threshold. The method then retrieves the image data associated with the position data that matches or falls within the user defined threshold. According to one practice, the method includes the steps of indexing the image and position data, receiving a user defined threshold, searching the position data for selected data that matches or falls within a user defined threshold, and retrieving the image data associated with the position data that matches or falls within the user defined threshold.

According to another aspect, the invention provides an image acquisition and retrieval system for acquiring and retrieving image data associated with an image of an object. The system includes an image acquisition element for acquiring the image data associated with the image of the object, and a receiver for receiving position signals associated with the position of the object. The system also includes a facility for correlating the position data with the image data, storage for storing one or more of the position data and said image data, and a control facility for retrieving the image data stored in the storage element based upon the position data. According to one practice, the image acquisition element is a scanner or a camera.

According to one aspect, the system includes a printing facility for reproducing the image from the image data.

According to another aspect, the receiver is configured for receiving position signals from a global positioning system (GPS) satellite constellation located in orbit around the Earth. The position signals are representative of a geographical location of the object.

According to still another aspect, the system receives a user defined threshold or search query, and retrieves selected image data correlated with the position data that relates to (e.g., satisfies) the user defined threshold.

The present invention also provides for an image acquisition system for acquiring an image of an object, the system includes a housing having an image acquisition element for acquiring the image of the object, and a receiver associated with said image acquisition element for receiving position signals associated with the geographic position of the object.

Other general and more specific objects of the invention will in part be obvious and will in part be evident from the drawings and description which follow.

### BRIEF DESCRIPTION OF THE DRAWINGS

The foregoing and other objects, features and advantages of the invention will be apparent from the following description and apparent from the accompanying drawings, in which like reference characters refer to the same parts throughout the different views. The drawings illustrate principles of the invention and, although not to scale, show relative dimensions.

FIG. 1 is a schematic block diagram of the image access and retrieval system in accordance with the teachings of the present invention.

FIG. 2 is a more detailed schematic view of the image access and retrieval system of FIG. 1 illustrating the components of the system employed to obtain position data in accordance with the teachings of the present invention.

FIG. 3 is a schematic block diagram depicting the major components of an electrophotographic printing system suitable for receiving, capturing or acquiring image and position data in accordance with the teachings of the present invention

FIG. 4 is a schematic flow chart diagram depicting the method of operation of the of the image access and retrieval system of FIG. 1 in accordance with the teachings of the present invention.

### DESCRIPTION OF ILLUSTRATED EMBODIMENTS

The present invention provides for an image acquisition and retrieval system that acquires an image of an object, as well as data corresponding to the position of the object. The acquired position data is correlated with the image data, and then stored in memory to form an image database. The system then searches the image database to retrieve selected ones of the stored images that correspond to user defined search criteria. For example, a user can provide a search query requesting images that relate to a specific geographical location or vicinity. The image acquisition and retrieval system then searches the database of images and retrieves those images that correspond to the geographical vicinity defined in the foregoing search query. The image acquisition and retrieval system is adapted to compare the user input position data with the stored position data, and when one or more position data meet the search criteria, retrieving the images associated therewith. The system can also rank or list the retrieved images in a selected order, such as listing first those images having associated position data that better match the search criteria. In terms of geographical location, the better matches correspond to position data that is closer to the search criteria relative to other position data that also meet the search criteria.

For purposes of discussion below, it is helpful to define a few terms.

The term “position” or “position data” is intended to refer to the position or data associated with the position of an object, receiver or both relative to Earth, and preferably includes the geographic position or location of the object. The geographic position can be expressed in any suitable format, such as a place of reference, such as a street, landmark, historic site, county, town, city, state, or country, or in an angular distance of a celestial body, such as by providing the longitude and latitude of a particular location on Earth. Those of ordinary skill will readily recognize that although the receiver can be mounted in the image acquisition stage, the description below generally refers to acquiring position data associated with the position of the object, since this can be easily inferred from the position of the receiver in the image acquisition stage.

The term “correlate” is intended to include associating or correlating a first data type with a second data type, and can include using the first data type as a marker or tag in connection with the second data type, or providing a general data association scheme within the system, such as by storing the first data type separate from the second data type. According to one practice, the first data type is position data and the second data type is image data. The association can be a direct association, where the position data is stored as a tag or marker with the image data, or an indirect association, where the position data can be associated with the image data according to any well known association scheme, such as look-up tables and intermediate flags, markers or pointers.

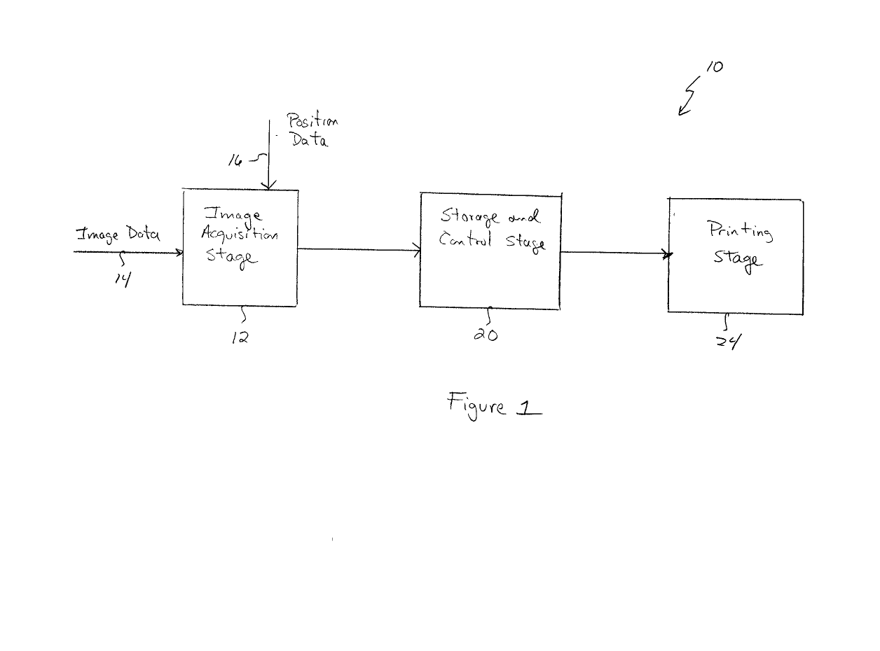

FIG. 1 is a schematic block diagram of the image acquisition and retrieval system in accordance with the teachings of the present invention. The illustrated image acquisition and retrieval system 10 includes an image acquisition stage 12 that acquires or receives image data 14 and position data 16. The image acquisition stage 12 generates selected output signals that correspond to the acquired image and position data. The image and position data can then be optionally stored in a storage and control stage 20. The illustrated storage and control stage 20 can include any suitable storage for storing the image and position data to create a database of images, examples of which include RAM, ROM, and the like, and preferably includes one or more magnetic storage devices, such as a hard disk. The storage and control stage 20 can also include an arrangement for controlling the retrieval from or transfer to of image and position data, as well as controlling the transfer of the image data to an optional printing stage 24 according to a user or system defined preference. Those of ordinary skill will readily recognize that the image and position data 14 and 16 can either be stored at the storage and control stage 20, or at any other convenient location, such as at the image acquisition stage 12. If desired, the storage and control stage 20 can output selected signals to the printing stage 24, which can include any suitable apparatus for reproducing the image on a substrate, such as a conventional printer or copier, both of which are known and well characterized in the art.

The printing stage 24 can be any suitable type of printing system. For example, the printing stage 24 can employ a raster output printer design, an ink jet printer, an ionographic printer, a thermal printer, a photographic printer, and the like. Furthermore, the printing stage 24 can be incorporated in an electronic display system, such as a CRT, LCD, LED, or other like image scanning, processing, or recording systems, or alternatively, other signal transmitting, receiving and recording systems.

The image acquisition and retrieval system 10 is not limited to the system or arrangement of system components described and shown in FIG. 1. Rather, the image acquisition and retrieval system 10 can employ a subset of the components illustrated in FIG. 1, such as only the image acquisition stage 12, or any number of different types of components or arrangement of components. The image acquisition and retrieval system 10 can also be any type of image reproducing system, examples of which include electrophotographic, electrostatic, ionographic, and other types of image forming or reproducing systems that are adapted to acquire, receive, retrieve and/or store image data associated with a particular object. The illustrated image acquisition and retrieval system 10 of the present invention is intended to be implemented in a variety of environments, such as in any of the foregoing types of image reproducing systems, and it is not intended to be limited to the specific system design or arrangement described herein.

The teachings of the present invention can further be employed in connection with a discrete, separate image acquisition device, such as a digital camera or a digital scanner, which are adapted to capture or acquire image data, and which are modified to receive position data. For example, the image acquisition and retrieval system 10 can be constructed as a digital camera, and hence only employ the image acquisition stage 12. The camera can employ an onboard storage facility, such as a removable storage element, for storing acquired digital image data. This removable storage element can then be employed in connection with a remote processing system, such as an image reproducing system or personal computer, to download digital image data thereto for further processing and manipulation. The image acquisition device can also be configured to receive and/or store position data from an off-board receiver, or from a receiver mounted on-board the device.

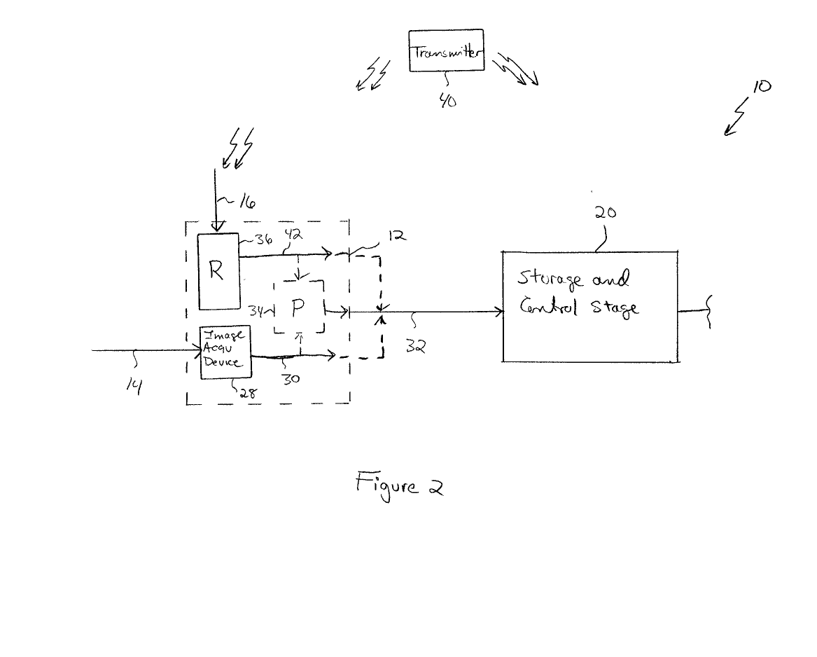

FIG. 2 is a more detailed schematic depiction of the image acquisition and retrieval system 10 of FIG. 1. The image acquisition stage 12 of the image acquisition and retrieval system 10 can include an image acquiring device 28 for acquiring an image of an object, as illustrated by image data arrow 14. The image acquiring device 28 can be any suitable acquisition device, such as a CCD array, that is configured for acquiring and then producing digital output signals corresponding to digital image data. The output signal 30 generated by the image acquiring device 28 can be forwarded directly to the storage and control stage 20 via any appropriate communication pathway 32, or can be introduced to an optional intermediate processor 34. The illustrated intermediate processor 34 can be positioned to receive and process the digital image data corresponding to the digital output signals 30 generated by the image acquiring device 28.

The illustrated image acquisition stage 12 further includes a receiver 36 for receiving position data signals 16 generated by a transmitter 40. The receiver 36 then generates an output signal 42 which can be communicated directly to the storage and control stage 20, or can be inputted to the intermediate processor 34. In this arrangement, the intermediate processor 34 processes the position data signals 16 received by the receiver 36 to extract selected position data corresponding to the position or location of the object. As set forth above, the image acquisition stage 12 includes the receiver 36, and hence the position data corresponds to the location of the image acquisition stage 12. However, those of ordinary skill will recognize that the location of the object can be easily inferred from this information. For purposes of simplicity, the position data received by the image acquisition stage 12 is referred to as the position data of the object. The intermediate processor 34, or any associated processing circuitry provided as part of the storage and control stage 20, can extract selected position data, such as data corresponding to the geographical location or position of the object, from the output signals 42 generated by the receiver 36. Although illustrated as part of the image acquisition stage 12, the receiver 36 can also be separate or remotely located from the image acquisition stage 12, and communicates with the image acquisition stage 12 via any suitable communication port or pathway.

The illustrated image acquisition stage 12 can be a separate, discrete component, that can later be coupled to the storage and control stage 20. For example, the image acquisition stage 12 can be a portable digital camera that employs an external housing containing the image acquiring device 28, the receiver 36, a suitable storage facility, such as a removable memory module, and any appropriate processing circuitry. Digital cameras are well know and characterized, and need not be described in further detail herein. Moreover, the receiver 36 can also be separate or remotely located from the image acquisition stage 12, and communicates with the image acquisition stage 12 via any suitable communication port or pathway. According to one practice, the receiver 36 can be placed at a selected location and configured to receive position signals from the transmitter 40. The camera can be connected to the receiver to receive position data corresponding to the position of the receiver. This position data can be stored on-board the camera. The camera user can subsequently acquire images, and the stored position data can be correlated with the acquired image data. Conversely, the images can be acquired by the camera, and then the camera can be coupled to a receiver to acquire the position data. The position data, acquired after the images, can then be correlated with the images. According to another practice, the receiver can be mounted in the camera and position data can be received before, during or after image capture.

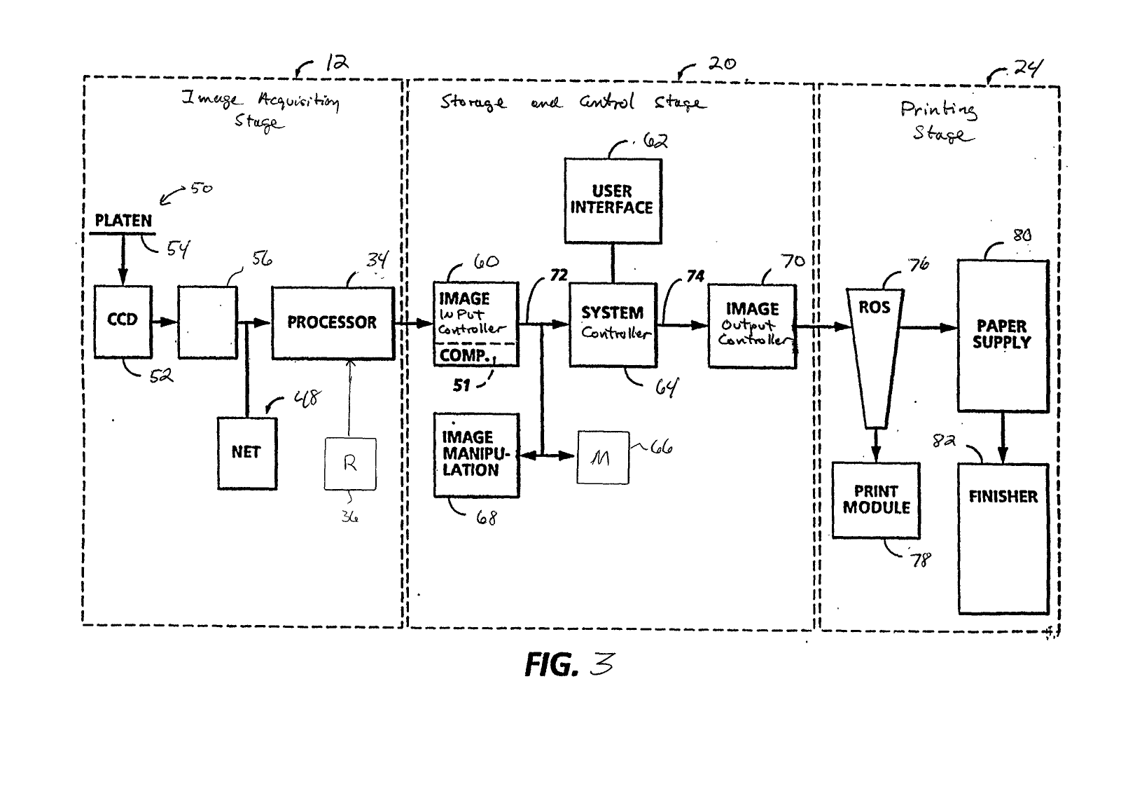

According to another embodiment, either the image acquisition stage 12 can be part of a larger image reproducing system, or the image acquisition and retrieval system 10 of FIG. 1 can be configured as an image reproducing system, such as an electrophotographic printing system. FIG. 3 is a schematic block diagram depicting the major components of an electrophotographic printing system suitable for receiving, capturing or acquiring image and position data in accordance with the teachings of the present invention. The illustrated system, for purposes of explanation, can be divided into multiple sections according to functionality, such as into the image acquisition stage 12, the storage and control stage 20, and a printing stage 24. The image acquisition stage 12 can include both local (e.g., on-site) and remote image and position data inputs, thus enabling the system to provide network, scan, and print services in a single integrated system. Other system combinations and arrangements can also be employed in the system and are obvious to the ordinarily skilled artisan, such as a stand alone printing system with on-site image input (i.e., a scanner), controller, and printer assemblies; a network printing system with remote input, controller, and printer assemblies; a printing system configured to receive remotely generated image and position data; and like system configurations. The printing stage 24 can be formed as illustrated, or can employ any of the foregoing printing arrangements.

With reference to FIGS. 2 and 3, for remote or off-site acquisition or inputting of image and/or position data into the system, the image acquisition stage 12 can include a network interface 48 with a suitable communication channel, such as a telephone line, enabling image and/or position data to be inputted or introduced to the image acquisition stage 12 from one or more remote sources for processing. Other remote sources of image and/or position data such as streaming tape, floppy disk, video camera, digital camera, and the like are also contemplated by the present invention.

For on-site image input, the image acquisition stage 12 can include a scanner 50 that can employ a universal or automatic document handler (not shown) for the purpose of manually or automatically placing and locating images for scanning. The scanner 50 can incorporate one or more linear light sensitive or photoelectric arrays 52, such as the illustrated charge-coupled device (CCD), for reciprocating scanning movement below a glass platen 54. Light reflected from the document on the platen 54 is focused by an associated optical arrangement onto the photoelectric array 52, which produces electric output image signals. Hence, the photoelectric array 52 provides image elemental signals (or pixels) representative of the image scanned by the scanner 50. These signals are introduced to a digital converter 56 for converting the electric image signals generated by the photoelectric array 52 into digital image signals. The digital image signals are then introduced to a processor, such as the processor 34, for further processing.

The illustrated processor 34 processes the digital image signals generated by the converter 56 as required to enable the storage and control stage 20 to manipulate, store and handle the image data in a form and order required to carry out a user defined function, such as a selected image search or print job. The processor 34 can also be configured to enhance or change the image data, such as by filtering, thresholding, screening, cropping, scaling (reduction/enlargement), and the like. Following any changes or adjustments made to the image data, the processor 34 then communicates the image data signals to the storage and control stage 20. Similarly, image signals received via the network interface 34 are conveyed to the processor 34, which in turn forwards the image data to the storage and control stage 20.

For on-site position data input, the image acquisition stage 12 can also include a receiver 36 that is adapted to receive position signals generated by the transmitter 40, FIG. 2. The receiver then generates an output position signal that is transferred to the processor 34. The processor can process and correlate the image and position data, and then transfer the data to the storage and control stage 20. The position data can be acquired before, during or after image capture of receipt of the image data.

Referring again to FIG. 3, the storage and control stage 20 is, for explanation purposes, divided into an image input controller 60, user interface (UI) 62, system controller 64, main memory 66, image manipulation section 68, and image output controller 70. The image and position data outputted by the processor 34 of the image acquisition stage 12 is received by the image input controller 60. The image input controller 60 can include a compression section 51 for compressing the image data with a compressor or processor to consolidate the image data for storage. The compressed image data can be temporarily stored in the main memory 66, which can comprise a random access memory (RAM) or a suitable hard disk assembly.

The user interface 62 can include a combined user controller/CRT display consisting of an interactive touchscreen, keyboard, and mouse. The user interface 62 preferably enables the user to interface with the printing stage 24, so as to program print jobs and other instructions, and to obtain system operating information, instructions, programming information and icons, diagnostic information, visual document facsimile display and pictorial views, and the like. Furthermore, in accordance with the teachings of the present invention, the user can provide a search query to retrieve selected images based on position data. Items displayed on the touchscreen 62, such as files and icons, are actuated by either touching the displayed item on the screen 62 or by using the mouse 66 to manipulate a cursor 67 to select an item.

When the image data stored in the main memory 66 requires further processing, the stored data can be accessed in the main memory 48 and transferred to the image manipulation section 68 where additional processing steps, such as collation, make ready, decomposition, and other operations are carried out. Following processing, the image data can be returned to the main memory 66, sent to the user interface 62 for display on the touchscreen, or sent to the image output controller 70. These operations are all performed under the auspices of the system controller 64.

The image data received by the image output controller 70 can be decompressed and readied for printing by associated image generating processors that can form part of the storage and control stage 20, such as by the image output controller 70 or the system controller 64, or can form part of the printing stage 24. Image data received by the printing stage 24 for printing can be purged from the main memory 66 in order to provide sufficient memory capacity for new image data received by the storage and control stage 20, or can be permanently stored in the main memory 66. As illustrated, the image data is transferred between the various components of the storage and control stage 20 along memory buses 72 and 74.

Referring again to FIG. 3, the illustrated printing stage 24 can include a laser type printer, and for purposes of explanation, is separated into a raster output scanner (ROS) section 76, a printer module 78, a paper supply section 80, and a finisher stage 82. The ROS section 76 can employ a radiation source, such as a laser, to provide one or more imaging beams that are scanned across a moving photoreceptor of the print module 78 by any suitable structure, such as by a rotating polygon. This creates a latent electrostatic image on portions of the photoreceptor, which can be subsequently developed by a developer stage in accordance with known techniques, and then transferred to a print media delivered by the paper supply section 80. As will be appreciated by those skilled in the art, the print media can comprise a selected one of various known substrates which are capable of accepting an image, examples of which include transparencies, preprinted sheets, vellum, glossy covered stock, film and the like. The print media can also comprise any of a variety of sheet sizes, types, and colors, and for this, plural media supply trays of the paper supply section 80 can be provided. The developed image transferred to the print media can be permanently fixed or fused and the resulting prints discharged to either an output tray or to the finisher 82. The finisher 82 provides certain finishing selections such as a stitcher for stitching or stapling the prints together to form books, a thermal binder for adhesively binding the prints into books, and/or other finishing options such as slitting, perforating, saddle stitching, folding, trimming, or the like.

The illustrated system controller 64, or a printer system controller that forms part of the printing stage 24, can be employed to control the printer functions and operations in accordance with selected job program parameters received from the system controller 64, as well as from internally derived signals from sensors and processes within the printing stage 24. The user interface 62 allows an user to define or select the parameters of a job program or a search query.

With reference to FIGS. 1 to 3, the image acquisition and retrieval system 10 whether constructed as an image reproducing system or as a digital camera, is configured to receive position data from the transmitter 40. With particular reference to FIGS. 1 and 2, the position data that the image acquisition and retrieval system 10 receives and processes to provide geographic and distance information can be derived from a variety of sources. By way of example, the transmitter 40 can be a Global Positioning System (GPS) satellite constellation, one or more ground based microwave transmitters and receivers, or electromechanical sensors operating in combination with a gyroscope, compass, and/or ground based acoustic transducers.

According to a preferred practice, the illustrated transmitter is a GPS satellite constellation. The satellites in the constellation provide real-time navigation and position data to anyone on earth with an appropriate GPS receiver. Accordingly, the receiver 36 can be a GPS receiver. The operation of the GPS is conceptually straight forward. Each GPS satellite transmits a microwave radio signal that details the satellite identification number, its internal atomic clock, and the orbital location (in latitude and longitude) of the satellite. The elapsed time between the signal transmission, which is calibrated to an on-board atomic clock, and the receipt at the GPS receiver, which has its own internal clock and antenna, divided by the speed of light, is roughly the distance to one satellite. By computing the distance from each of three satellites, a triangulation is effected which enables the ground-based GPS receiver to determine its own position on the earth's surface. By computing the distance to each of four or more satellites, the GPS receiver can determine its position in three dimensions, including height.

GPS receivers suitable for use in the present invention are commercially available from a variety of manufacturers. By way of example, the GPS NAV 100 and the TRAXXAR 6 channel GPS receivers are available from Motorola and Magellan, respectively. Typically, these GPS receivers have location accuracy's in the range of 25 meters. However, for greater accuracy, users can turn to differential GPS, commonly denoted as DGPS, which provides accurate position data to within about one foot. DGPS is widely used and well characterized in the art. For example, operationally, DGPS employs a local “master” GPS receiver which is positioned at a known location and linked to a transmitter, and a “slave” GPS receiver. The master and the slave receivers are linked together, for example, by a local UHF or VHF radio link. The master GPS receiver determines its coordinates from the GPS constellation, calculates a correction factor, and then transmits the correction signal to any slave in an extended geographical region about the master via the local radio link. The slave processes the correction signal along with its own GPS-determined coordinates and determines the slave location at a significantly improved accuracy over normal GPS receivers. An example of a portable DGPS unit is the Motorola LGT 1000 TM.

According to alternate embodiments, the transmitter 40 can include a plurality of ground-based transmitters, such as a phased array of microwave antennas. The receiver 36 receives signals generated by the transmitter and either the processor 34 or the storage and control stage 20 can measure the phase difference between the signals generated by the antennas and received by the receiver 36 to derive position data generally associated with the position of the object. Further, the receiver 36, which can be configured as an acoustic transducer, can be adapted to receive acoustic signals generated by the transmitter 40, which can be configured as an acoustic generator or source, to determine the position of the object. Since sound travels at a known speed in atmosphere (340 meters/second), it can be used like any other ranging system. Additionally, since sound travels at a much slower rate than does radio frequency or microwave frequency signals, the complexity of the electronics is greatly reduced.

With reference to FIG. 2, the image data associated with the output signal 30 generated by the image acquiring device 28 and the position data associated with the output signal 42 generated by the receiver 36 can be directly inputted to the storage and control stage 20. The illustrated storage and control stage 20 can employ any suitable storage facility, such as a hard disk drive or other memory device, and associated processing circuitry, all adapted to receive, process, store and retrieve the image and/or position data generated by the image acquisition stage 12. The illustrated storage and control stage 20 can further include any appropriate data or document management application software that can be employed to store, manage and retrieve image data from a particular storage location. The software stored in the storage and control stage 20 can include an indexing facility that employs appropriate search functions to enable a user to input search queries or commands in order to search, access and retrieve a particular image based on position data. Those of ordinary skill in the field of electrical and computer engineering will readily recognize that standard interface and data management software can be modified, or wholly created in accordance with the present teachings, that is configured to accept selected search queries, and in response, search a database of images to retrieve a selected image. Commercially available application programs of this type which can be readily modified in accordance with the teachings of the present invention, and suitable for use with the proper interface software, include PagisPro and Scanworks application programs manufactured by Scansoft, Inc., Peabody, Mass., U.S.A.

In a preferred embodiment, the transmitter 40 is a GPS satellite constellation that generates position signals having associated position data 16. The position signals received by the receiver 36, FIG. 2, generally includes information corresponding to the latitude and longitude of the image acquisition stage 12. This information can be used to extrapolate the general location of the object. This geographical position data can be correlated with the image data by either the storage and control stage 20 or the image acquisition stage 12, such as by the intermediate processor 34. According to one practice, an intermediate look-up table can be employed that stores selected position data with one or more corresponding pointers to a particular memory location that stores corresponding image data. Those of ordinary skill will readily recognize that a number of storage and association schemes can be employed to create a relationship between image data and position data corresponding to the location of the object.

The position data correlated with each image acquired by the image acquisition stage 12 can be acquired at the time of image capture, or the position data can be acquired or updated after the image is acquired. The position data can be acquired at a selected time after image capture by acquiring an available and suitable GPS signal with a GPS receiver mounted either in the image acquisition stage 12 or at another secondary location, such as in the storage and control stage 20. Alternatively, the captured or acquired image data can be temporarily stored at the image acquisition stage 12 for a time sufficient for the receiver 36 to receive position signals corresponding to the geographical position of the object. Once the position and image data are acquired, the image and position data can be transferred to the storage and control stage 20 for further processing.

The illustrated storage and control stage 20 can correlate the position data with the image data, and then store the data at an appropriate memory location. Furthermore, the image data can be introduced or added to an indexing facility of the application software stored in the storage and control stage 20. As mentioned above, the position data can be geographical coordinates identifying the geographical position or location of the object, and can also be added or incorporated into the indexing facility of the application software and can be used to search for a selected image. A suitable process or method for inputting a search query and retrieving a desired image based on position data or information contained in the query is described below.

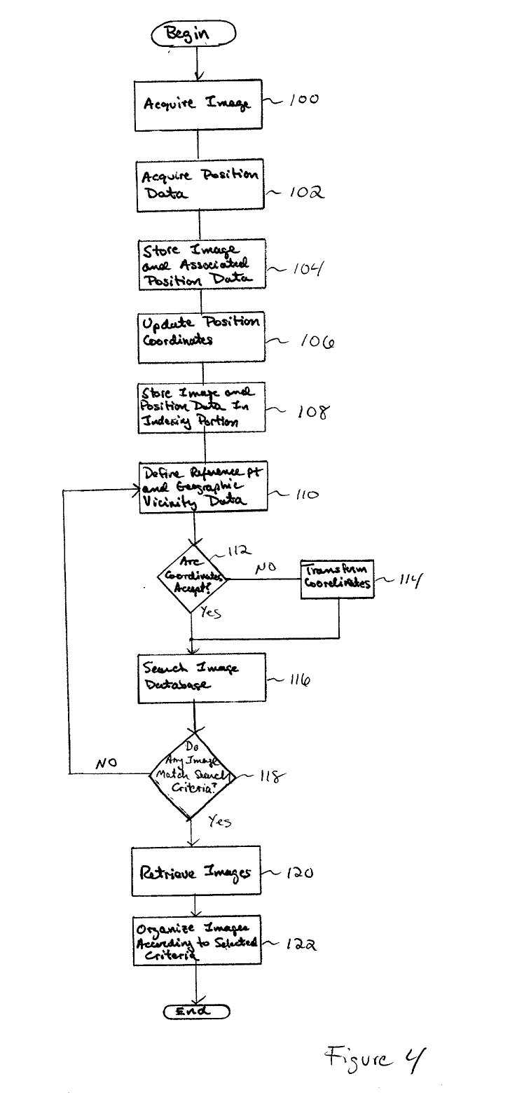

FIG. 4 is a schematic flowchart diagram illustrating the broad method of operation of the image acquisition and retrieval system 10 in accordance with the teachings of the present invention. The image acquiring device 28 of the image acquisition stage 12 acquires an image of an object, as set forth in step 100. The receiver 36 of the image acquisition stage 12 is configured to receive or acquire position data transmitted from the transmitter 40, which is preferably a GPS satellite constellation. The signals generated by the transmitter preferably contain angular distance information, such as the latitude and longitude of the object. This information is then received by the receiver 36, which is preferably a GPS receiver (step 102 of FIG. 4). The image and position data 14 and 16 can be stored either at the image acquisition stage 12, which can be a stand alone device such as a digital camera, or can be transferred along communication pathway 32 to the storage and control stage 20 (step 104 of FIG. 4). If at the time of image capture the position data is not immediately available, either the image acquisition stage 12 or the storage and control stage 20 can be constructed to update or refresh the position data upon availability of this information. This is set forth in step 106. Those of ordinary skill will readily recognize that the position data can be acquired before, during or after image capture, and that the receiver 36 can be mounted in the system 10 or can be separate from the system. In this latter arrangement, the receiver can be coupled to the system to transfer thereto position data via any suitable pathway, including optical, electrical, and the like. Moreover, the position data can be stored on-board the system or separate therefrom, provided that at some point the image and position data are correlated together.

The image and position data can then be stored, introduced or added to an indexing facility of the application software stored in the storage and control stage 20. The software stored in the storage and control stage 20 can include an indexing facility that employs appropriate search functions to enable a user to input search queries or commands in order to search, access and retrieve a particular image based on position data (step 108).

The application software program can be constructed so as to accept search or input parameters from a system user. The user can request the software to search for one or more images based on position data. For example, the user can define a geographic location or reference point, and a selected radius or distance from the reference point, and then request the storage and control stage 20 to access and retrieve all images that fall within, without, or which meet these position searching parameters. This searching information can be provided to the image acquisition and retrieval system 10 in the form of a search query (step 110 of FIG. 4). The reference point and geographic vicinity searching information can be expressed in terms of angular location or distance, such as latitude and longitude, or can be defined as a specific location, site, address, landmark or other user friendly input parameter. The image acquisition and retrieval system 10 checks the type of information supplied thereto (step 112), and if the searching information is expressed in terms of a specific location, and not in angular location information, transforms or converts the input information into angular distance coordinates (step 114). The system can employ any conventional mapping program to extract or derive this information from the information supplied by the user.

The image acquisition and retrieval system 10 then searches the database of images for images having correlated position data that satisfy the search parameters (step 116 of FIG. 4). The system performs this search by comparing the position data supplied by the search query with the stored position data to determine which data satisfies the search query. The system then retrieves the images correlated with the position data. If the system does not find any position data that satisfies the search query, the system does not retrieve or provide access to any images, and hence reverts to step 110 to enable the entry of another search query. The system can also be designed in any appropriate manner to handle and organize the images that satisfy the search query. For example, the system can retrieve the images and display them in any appropriate size, such as thumbnail sizes (steps 118, 120 and 122). The system can also be configured to list the images in any selected order, such as listing first the images that better satisfy the search query. For example, the system can list in descending order the images that are closest to the location defined by the search query.

A significant advantage of the present invention is that it provides for a simple and elegant system for acquiring, storing, searching and retrieving images based on correlated position data. Hence, the system allows a system user to retrieve quickly images of a selected location or region based on a user supplied geographic location.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

1. In an image reproducing system for reproducing an image of an object, the system having storage for storing image data associated with the image, a method for retrieving selected image data, comprising the steps of
acquiring an image of the object, said image including image data,
acquiring position data representative of the position of the object,
correlating the position data with the image data,
storing said image data and said position data in storage, and
retrieving said image data in storage based upon said position data.

2. The method of claim 1, wherein said step of retrieving comprises the step of, based upon a user defined threshold, retrieving selected image data having correlated therewith position data related to said user defined threshold.

3. The method of claim 1, wherein said step of acquiring position data comprises the step of receiving position signals from a global positioning system (GPS) satellite constellation, wherein said position signals are representative of a geographical location of the object.

4. The method of claim 1, wherein said step of retrieving comprises the steps of
providing user defined data representative of a geographic location,
searching said position data correlated with said image data for position data related to said user defined data, and
retrieving said image data correlated with said selected position data and corresponding to the user defined data.

5. The method of claim 4, further comprising the step of selecting position data relative to said user defined data that is within a selected geographic vicinity of said user defined data so as to retrieve image data associated with said selected position data that falls within a selected geographic vicinity of the geographic location represented by said user defined data.

6. The method of claim 1, further comprising the step of reproducing the image of the object based upon the retrieved image data.

7. The step of claim 1, wherein said step of retrieving comprises the steps of
defining a search parameter having as part of the parameter second pre-defined position data,
searching said stored position data for position data related to said second position data, and
retrieving the image data correlated with the related stored position data.

8. The step of claim 1, further comprising the steps of
providing an indexing facility having a search engine for indexing the image and position data,
searching with said search engine said position data having correlated therewith said image data for selected position data relative to a user defined threshold, and
retrieving said image data associated with said position data that matches or falls within said user defined threshold.

9. The method of claim 1, further comprising the steps of
indexing the image and position data,
receiving a user defined threshold,
searching said position data having associated therewith said image data for selected position data that matches or falls within a user defined threshold, and
retrieving said image data associated with said position data that matches or falls within said user defined threshold.

10. In an image reproducing apparatus for acquiring and reproducing an image of an object, the system having storage for storing image data associated with the image, a computer readable medium holding instructions for a method for retrieving selected image data, comprising the steps of
acquiring an image of the object, said image including image data,
acquiring position data representative of the position of the object,
correlating the position data with said image data,
storing said image data and said position data, and
retrieving said image data in storage based upon said position data.

11. The computer-readable medium of claim 10, wherein the method further comprises the steps of
providing user defined data representative of a geographic location,
searching said position data correlated with said image data for position data related to said user defined data, and
retrieving said image data correlated with said selected position data related to user defined data.

12. An image acquisition and retrieval system for acquiring and retrieving image data associated with an image of an object, said system comprising
an image acquisition element for acquiring the image data associated with the image of the object,
a receiver associated with said image acquisition element for receiving position signals associated with the position of the object,
means for correlating said position data with said image data,
a storage facility for storing one or more of said position data and said image data, and
a control facility for retrieving said image data stored in said storage element based upon said position data.

13. The system of claim 12, further comprising a printing facility for reproducing the image from said image data.

14. The system of claim 12, wherein said image acquisition element is one of a scanner and a camera.

15. The system of claim 12, wherein said receiver is configured for receiving position signals from a global positioning system (GPS) satellite constellation located in orbit around the Earth, wherein said position signals are representative of a geographical location of the object, and wherein said position signals include position data associated with the geographical location.

16. The system of claim 12, further comprising a processor coupled to said receiver for processing said position signals to determine the geographical location of the object.

17. The system of claim 12, further comprising means for receiving a user defined threshold, wherein said control facility includes means for retrieving selected image data correlated with said position data related to said user defined threshold.

18. The system of claim 12, further comprising means for receiving user defined data representative of a geographic location, wherein said control facility includes
searching means for searching said position data correlated with said image data for position data related to said user defined data, and
retrieving means for retrieving said image data correlated with said selected position data related to user defined data.

19. The system of claim 18, further comprising means for selecting position data relative to said user defined data that is within a selected geographic vicinity of said user defined data so as to retrieve image data associated with said selected position data that falls within a selected geographic vicinity of the geographic location represented by said user defined data.

20. An image acquisition system for acquiring an image of an object, said system comprising a housing having
an image acquisition element for acquiring the image of the object, and
a receiver associated with said image acquisition element for receiving position signals associated with the geographic position of the object.
